(19) United States
(12) Patent Application Publication
(10) Pub. No.: US 2007/0136107 A1
(43) Pub. Date: Jun. 14, 2007

(54) Method and system for determining automobile insurance rates based on driving abilities of individuals

(75) Inventors: Michael Maguire, Exton, PA (US); Scott Miller, Stratford, NJ (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: American International Group, Inc., New York, NY (US)

(21) Appl. No.: 11/299,600

(22) Filed: Dec. 12, 2005

(51) Int. Cl. G06Q 40/00; G06F 3/00

(52) U.S. Cl. 705/4; 715/764

(57) ABSTRACT

A method and system for determining an automobile insurance rate for a person by measuring a person's ability to perform a task or series of tasks, wherein the measurement correlates to a risk of loss. After the identity of the person seeking insurance is challenged and verified, a user interface device, such as a kiosk or the user's computer, is used to render an interactive test that measures, for example, the person's dexterity and metal concentration. The test results are collected electronically and analyzed to provide one or more scores based on the abilities of the person to finish the test objectives. The score is used to derive a driving-abilities rate factor based on actuarial methodology and statistical data. The driving-abilities rate factor can then be used in combination with other underwriting factors to determine the automobile insurance rate for that person.

### FIELD OF THE INVENTION

The invention generally relates to automobile insurance, and, more particularly, to a computer-assisted method and system for determining automobile insurance rates for individuals.

### BACKGROUND OF THE INVENTION

Automobile drivers purchase insurance to cover personal injuries and vehicle damages caused by automobile accidents. The determination of the insurance rates is an actuarial process that takes into account various factors, such as the person's driving history, the miles driven in a year, the years of experience of driving, the geographic location, certain demographic data such as age and gender, the type of vehicle owned by the person, etc. Such factors commonly used for underwriting the automobile insurance are largely based on statistical analysis of historical data for predicting the probabilities of the person to be involved in accidents in the future.

Conventional rating factors have been used successfully to determine automobile insurance premiums, but are somewhat incomplete. One significant aspect that has not been included is the present state of the dexterous and cognitive abilities of the particular person seeking insurance. Such factors have heretofore not been considered in the underwriting calculation. As a consequence, the insurance rates often do not reflect precisely how safely and effectively the insured can operate an automobile. Using conventional underwriting methodology, two persons may be given the same insurance rate based on the standard demographic and experienced based underwriting factors, even though their current abilities in operating an automobile differ drastically.

### SUMMARY OF THE INVENTION

The systems and methods of the invention provide a new way to efficiently and accurately determine the automobile insurance rate for an individual by measuring indicia reflective of the abilities of the particular individual to operate an automobile, such that the insurance rate more accurately reflects the future risks of damages associated with that individual.

Relatedly, the method and system of an aspect of an aspect of the invention allows the driving abilities of a potential insured to be evaluated and factored into the calculation of the insurance rate for that individual.

In accordance with a preferred embodiment of the invention, a user interface device, such as a kiosk or a personal computer is used to administer an interactive test designed to assess a person's driving abilities. After the identity of the person seeking insurance is challenged and verified, the test is rendered using the user interface device. The test may involve tasks that measure, for example, the person's dexterity and level of concentration. The test results are collected by a server, preferably via a computer network such as the Internet, and analyzed to provide one or more test scores based on the abilities of the person to finish the test objectives. The test score is used to determine a driving-abilities rate factor based on actuarial methodology and statistical data. The driving-abilities rate factor can then be used alone or in combination with other underwriting rating factors to determine the automobile insurance rate for that person.

Further objects and advantages of the method and system for processing insurance transactions can be seen in the following detailed description of an embodiment of the invention with reference to the drawing, in which:

### BRIEF DESCRIPTION OF THE DRAWINGS

FIG. 1 shows a schematic view of a computer system implementing an embodiment of the invention for collecting information relating to the driving abilities of a person seeking automobile insurance and using such information in determining the insurance rate for that person;

FIG. 2 is a flowchart showing an embodiment of a method of collecting information on the driving abilities of a person and utilizing that information to determine an insurance rate for the person;

FIGS. 3-6 show exemplary user interface screens representing different tasks to be carried out by the person seeking insurance for interactively evaluating the abilities of the person to operate an automobile; and

FIG. 7 is a schematic diagram illustrating test results being factored into the calculation of the insurance rate for the person seeking insurance.

### DETAILED DESCRIPTION OF EMBODIMENTS OF THE INVENTION

The present invention is directed to a method and system for determining the automobile insurance rate for a person seeking insurance that takes into account the ability or fitness of the person to operate an automobile. To that end, as part of the underwriting operation, an interactive test is rendered to collect data indicative of the person's abilities to operate an automobile. The test results are then analyzed for deriving a rating factor that is used in determining a proper insurance rate for that particular person. Although, the term “automobile” is used throughout this specification, it will be appreciated by persons of skill in the art that the methods and systems described herein are applicable to many different types of insurance including, without limitation, insurance relating to various types of motorized vehicles such as cars, trucks, vans, buses, motorcycles, boats and other watercrafts, and airplanes, etc.

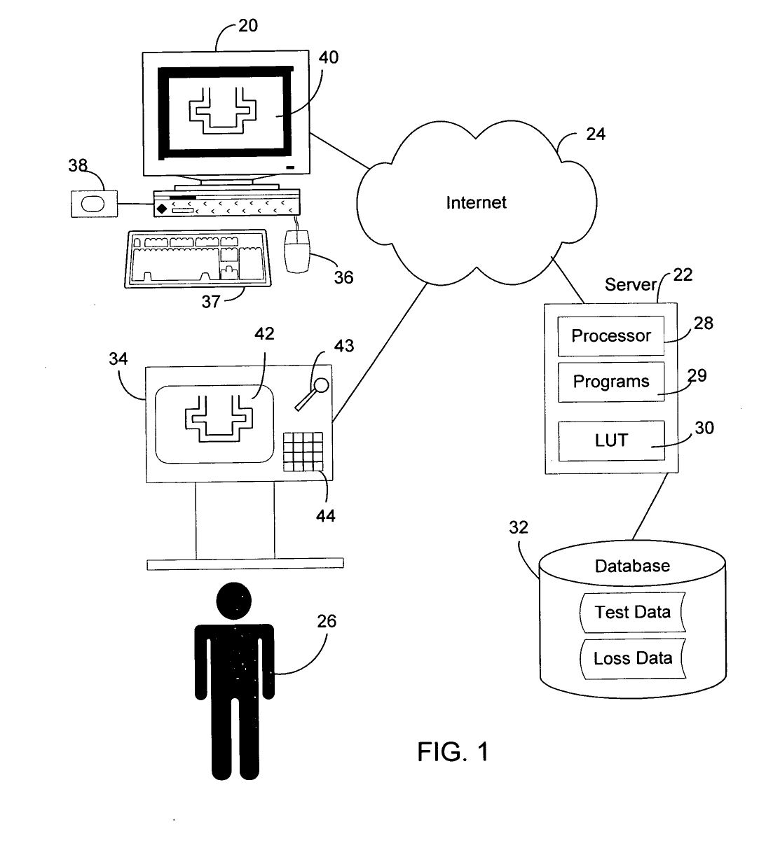

Referring now to FIG. 1, in one embodiment, a computerized system for underwriting automobile insurance includes a user interface device 20 for interacting with a person 26 seeking insurance, and a server 22 that collects pertinent information regarding the individual. Server 22 is associated with, and/or may host, applications that perform calculations to determine the insurance rate for the person based on various parameters, including a rating factor reflecting the abilities of the person to operate an automobile. The user interface device 20 is connected to the server 22, preferably via a computer network 24, to allow the user to interact with the server 22 for purposes of taking a test for measuring the driving abilities of the user, as described in greater detail below. In one scenario, the server 22 may be connected to and accessible via the Internet. The server 22 generally includes a processor 28 and one or more applications or programs 29 for receiving underwriting data and performing calculations for determining insurance rates. A database 32 may contain insurance statistical data that can be used to assist the assessment of insurance rates.

The user interface device 20 may be, for example, a personal computer of the person seeking insurance, or a computer of a representative of the insurance company. Alternatively, the user interface device may be a dedicated kiosk 34. The user interface device 20 has a suitable user input device, such as mouse 36 or a keyboard 37, that may be used by the person seeking insurance to accomplish tasks as part of the driving abilities test, and may have other input devices 38 for functions such as verifying the user identification as described in greater detail below.

In accordance with a feature of the invention, the abilities of the person 26 seeking insurance to operate an automobile is tested as part of the underwriting process, and the test results is used to derive a rating factor that is considered in calculating the insurance rate for that particular individual. It will be appreciated that the test results are indicative of the present state of the abilities of the person to operate a vehicle and are thus highly pertinent in predicting the future risks of the person to be involved in automobile accidents. The ability to take into consideration the present abilities of the insured to operate an automobile has many benefits for both the insured and the insurance company. For example, younger drivers are quite often charged with higher premiums due to their limited driving experience. If, however, those less experienced drivers can establish, through the use of an interactive test, a greater than average ability to operate a vehicle in a safe and effective manner, then the insurance company can justify providing lower rates for them. One the other hand, if a person seeking insurance shows poor abilities to operate a vehicle, the insurance company can require a higher premium to better match the potential risk of loss it is assuming by providing insurance to that driver.

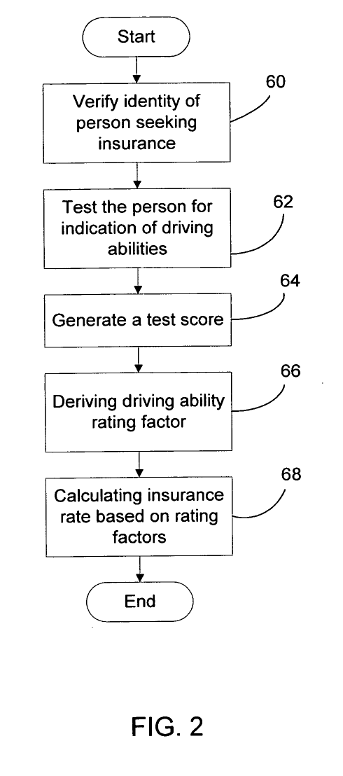

Turning now to FIG. 2, before the test of driving abilities is rendered to a person 26, the person's identity has to be confirmed to ensure that the person taking the test is actually the person to be insured (step 60). The user identification can be ascertained in various ways. For instance, biometric devices may be used to identify an individual based on fingerprints, voice recognition, face recognition, iris scan, hand geometry, or signature verification. Alternatively, the user may be required to enter a password, and the system uses the password and corroborating data elements to verify the identity of the person. As another alternative, the identification may employ digital chip technology using an embedded electronic chip or an electronic chip embedded in another identifying device such as a credit/debit card or driver's license. Also, the identification may be made by physical inspection of the person's identification documents, such as a driver's license, by a representative (e.g., insurance agent) of the insurance company. It will be appreciated that these alternative ways of ascertaining the identity of the person seeking insurance are provided here only as examples and are not intended to limit the scope of the invention.

Once the identity of the person seeking insurance is verified, an interactive test is given to the person by means of the user interface device 20 (step 62). To that end, the user interface device 20 has a display device and at least one input device for entering the user response. For instance, if the user interface device is a personal computer, the display device may be the screen 40 of the computer monitor, and the input device may be a mouse 36 and/or a keyboard 37. If the user interface device is a kiosk 34, the kiosk may be equipped with a touch-sensitive screen 42, and the screen may also be used as the input device to receive the user input when the person touches the screen with a finger or a pen. The kiosk 34 may also include other input devices, such as a joystick 43 or a keypad 44.

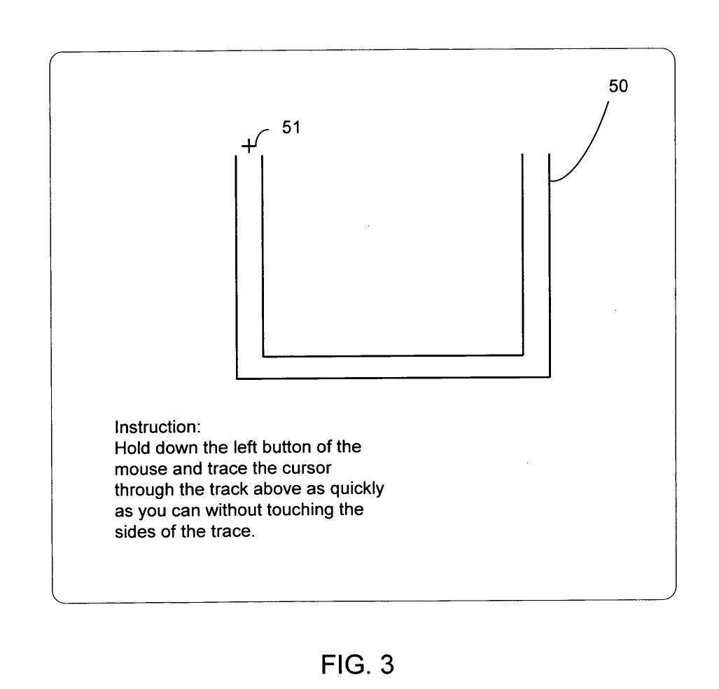

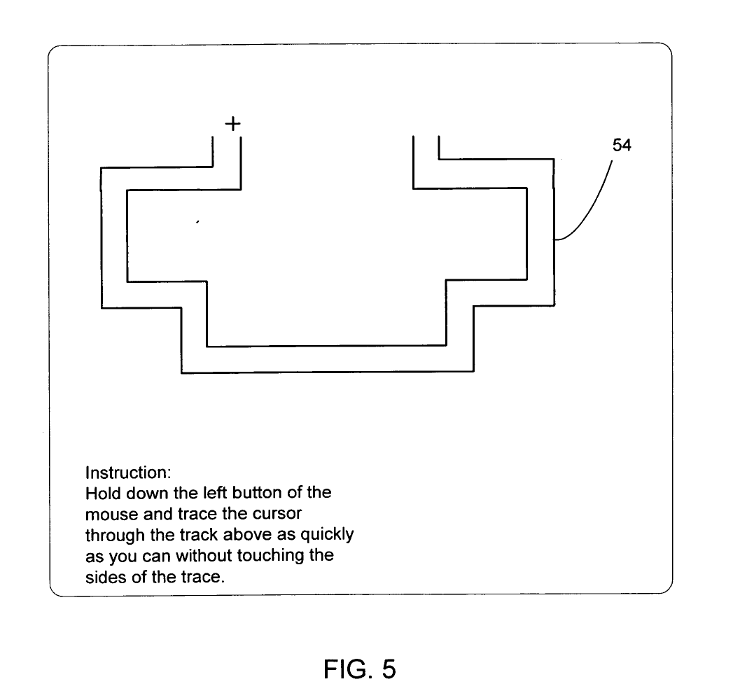

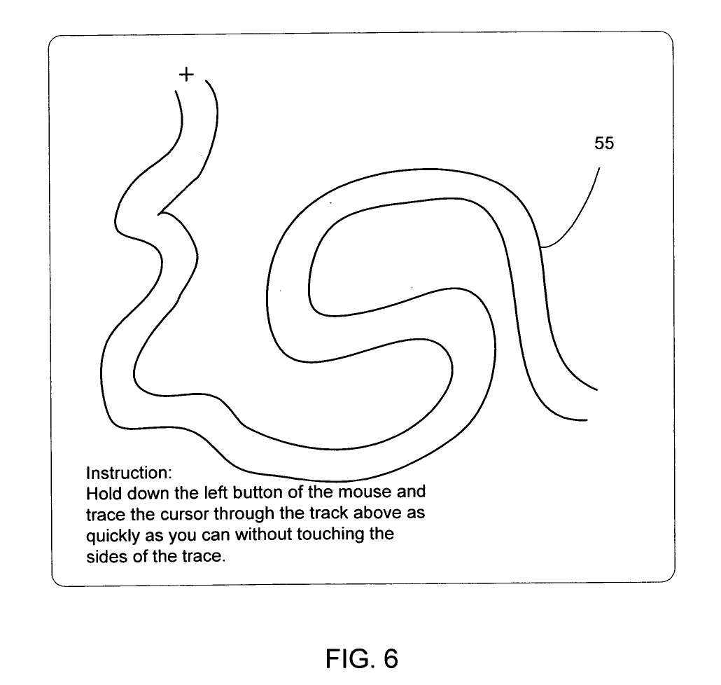

The interactive test is intended to measure parameters or characteristics that reliably correlate with risk of loss. The characteristics include, for example, the abilities of the person being tested to focus on a particular task, the accuracy of the person in completing the task, the speed in which the person completes the task. The performance of the particular individual in terms of these characteristics can be compared with the performance of others via actuarial methodology. Depending on its design, the test can take many different forms. By way of example, FIGS. 3-6 illustrate a sequence of tasks that may be used in a test for testing the dexterity, motor skills, and level of concentration of the person. It will be appreciated that those tasks are only one example of a test that can be rendered, and may other types of tasks can be designed to measure the desired indicators.

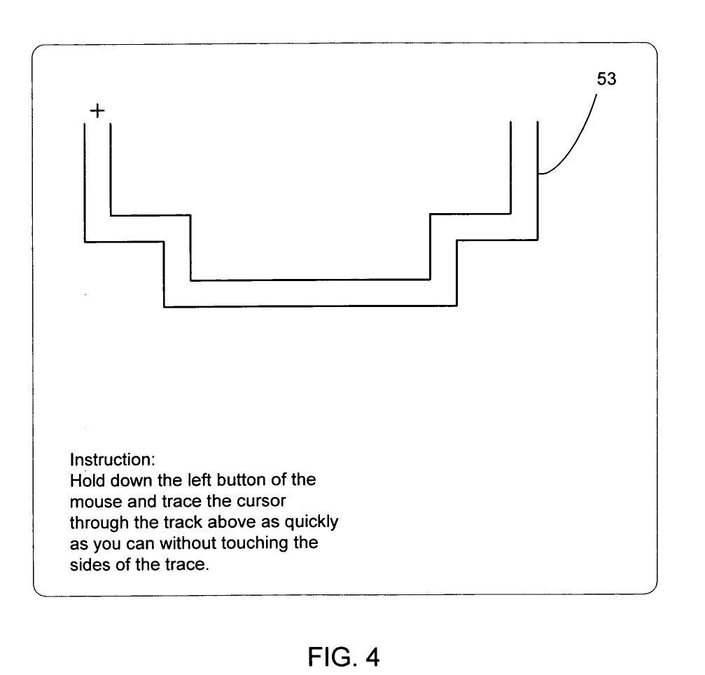

In the task illustrated in FIG. 3, the person receiving the test is presented with a simple track 50 displayed on the screen 40 of the computer 20, and is required to operate the mouse 36 to move a pointer or cursor 51 through the track. Alternatively, on a kiosk 34 with a touch-sensitive screen 42, the user may use a pen to trace through the track displayed on the screen, or use a joystick 43 to move a cursor through the track. The movement of the cursor 51 is monitored, and data is recorded as to the number of times, if any, that the cursor touches and/or traverses the boundary lines defining the track. The time it takes for the cursor to move from the start to the finish is also recorded. The exemplary tasks shown in FIGS. 4-6 are similar to that in FIG. 3, but with increasing complexity in the shapes of the tracks 53, 54, 55 to make it more difficult to move the cursor through successive tracks. The goal is to go through each track quickly without going off the track. The performance of the person receiving the test is determined by the amount of time the person takes to go through each track and how many times the person goes off the tracks. These data are collected for analyses.

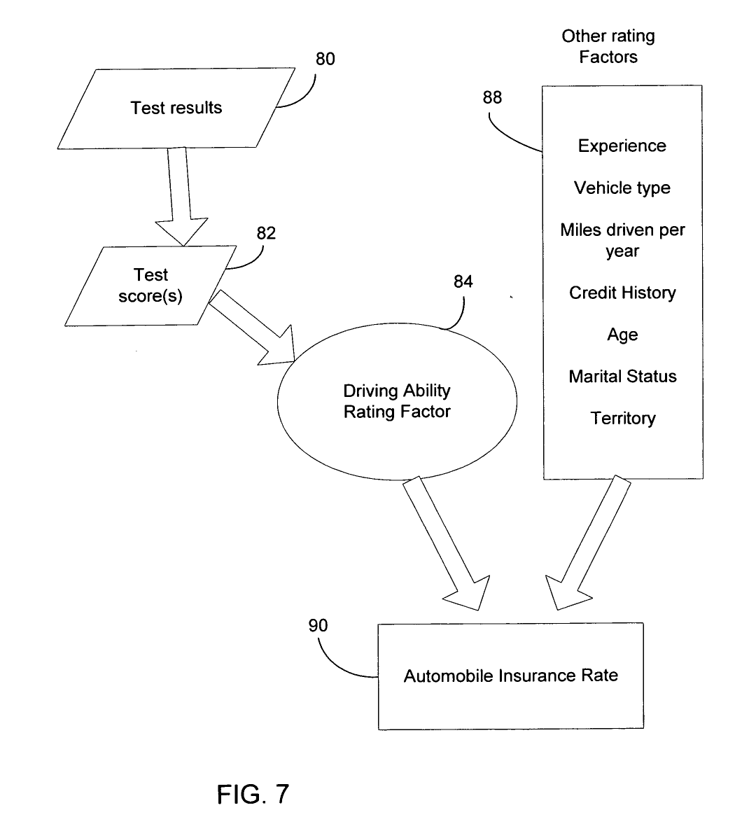

Returning to FIG. 2, once the interactive test is completed, the test results are analyzed (step 64). In one embodiment, the test results are transmitted to an application or applications associated with server 22 for analyses. As shown in FIG. 7, such application or applications may generate one or more scores 82 from the test results 80. For instance, an application associated with the server 22 may generate one overall test score based on the amount of time used and the number of errors made in accomplishing the tasks. Alternatively, an application associated with the server 22 may generate one score based on the amount of time and another score based on the degree to which the user successfully negotiated the track, wherein both scores facilitate a multi-dimensional regression analyses.

The test score or scores 82 generated from the test results 80 are then used to determine the value of a driving-abilities rating factor 84 that is used in calculating the insurance premium (step 66). The driving-abilities rating factor 84 may be determined using actuarial principles, such as by looking at the results of the test and comparing the results to the actual losses incurred by others who have received s similar test score. The test results and actual losses may be stored in the database 32 accessible by the server 22 to form the correlation analyses. Based on the accumulated test scores and loss data for a large number of insured individuals, the insurance company can reliably determine the correlation between the test scores and the insurance losses to generate a driving-abilities rating factor that is indicative of the likelihood of future losses. The correspondence between the test score and the assigned value of the driving-abilities rating factor may be presented as a look-up table 30, which is used by the server 22 to locate or interpolate the rating factor value based on the test score of the person seeking insurance.

The driving-abilities rating factor 84 can then be used in the determination of the insurance rate 90 for the person seeking insurance (step 68). In a preferred embodiment, the driving-abilities rating factor is used together with other standard underwriting factors 88 in the insurance premium calculation. Those other standard rate factors include, for example, the past driving history of the insured, the miles driven per year, driving experience, the type of vehicle, the area in which the vehicle is operated, age, marital status, credit history, and other factors commonly used by insurance companies in assessing the automobile insurance premium.

In view of the many possible embodiments to which the principles of this invention may be applied, it should be recognized that the embodiment described herein with respect to the drawing figures is meant to be illustrative only and should not be taken as limiting the scope of invention. For example, those of skill in the art will recognize that the elements of the illustrated embodiment shown in software may be implemented in hardware and vice versa or that the illustrated embodiment can be modified in arrangement and detail without departing from the spirit of the invention. Therefore, the invention as described herein contemplates all such embodiments as may come within the scope of the following claims and equivalents thereof.

1. A method of determining an automobile insurance rate for a person seeking insurance, comprising:
verifying an identification of the person;
using a user interfacing device, giving an interactive test to the person, the test being designed to evaluate characteristics indicative of abilities of the person to operate an automobile;
receiving results of the interactive test;
analyzing the results of the interactive test to produce a driving ability rating factor; and
calculating an insurance rate for the person based on the driving ability rating factor.

2. A method as in claim 1, wherein the step of giving the test includes displaying a track on a display device and requiring the person to trace through the track.

3. A method as in claim 2, wherein the results of the interactive test include an amount of time used by the person to trace the track and a number of errors in tracing the track.

4. A method as in claim 1, wherein the step of verifying includes identifying the person seeking insurance by means of a biometric device.

5. A method as in claim 1, wherein the step of analyzing includes generating a test score for the person based on the test results, and deriving the driving ability rating factor according to the test score.

6. A method as in claim 1, wherein the step of calculating calculates the insurance rate based on the driving ability rating factor and other rating factors.

7. A method as in claim 1, wherein the step of receiving receives the results of the interactive test via the Internet.

8. A system for determining an automobile insurance rate for a person seeking insurance, comprising:
a user interface device for presenting an interactive test for evaluating characteristics of the person indicative of abilities of the person to operate an automobile; and
a server connected to the user interface device for receiving results of the interactive test, the server being programmed to analyze the test results to provide a driving ability rating factor and applying the driving ability rating factor to calculate an insurance rate for the person seeking insurance.

9. A system as in claim 8, wherein the user interface device is connected to the server via a computer network.

10. A system as in claim 9, wherein the computer network connecting the user interface device to the server is the Internet.

11. A system as in claim 8, wherein the user interface device is a computer.

12. A system as in claim 8, wherein the user interface device is a kiosk.

13. A system as in claim 8, wherein the user interface device is operated to present an interactive test comprising displaying a track on a display device and requiring the person to trace through the track.

14. A system as in claim 13, wherein the results of the interactive test include an amount of time used by the person to trace the track and a number of errors in tracing the track.

15. A system as in claim 8, wherein the user interface device includes a biometric device for verifying an identity of the person seeking insurance.

16. A system as in claim 8, wherein the server is programmed to generate a test score based on the test results, and to derive the driving ability rating factor based on the test score.

17. A system as in claim 8, wherein the server is programmed to calculate the insurance rate based on the driving ability rating factor and other rating factors.
